(19) United States
(12) Patent Application Publication
(10) Pub. No.: US 2007/0150370 A1
(43) Pub. Date: Jun. 28, 2007

(54) System for Increasing On-Line Shopping Presence

(76) Inventors: William E. Staib, Coralville, IA (US); Raymond J. Mlejnek, Coralville, IA (US); Andrew Yasinsky, Belmont, CA (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/560,326

(22) Filed: Nov. 15, 2006

Related U.S. Application Data
(60) Provisional application No. 60/737,072, filed on Nov. 15, 2005.

(51) Int. Cl. G06Q 30/00

(52) U.S. Cl. 705/26

(57) ABSTRACT

A method for creating an online mall by which a service provider obtains product information for one or more products from merchant web sites, wherein the product information includes total price data for the one or more products; and creates a shopping cart web site for at least one merchant as a function of the product information obtained from that merchant's web site. A new price is set for the one or more products on the created shopping cart web site, wherein the new price is responsive to the total price data for the one or more products and the on-line mall's own pricing analysis, and wherein the shopping cart web site is adapted to take orders for one or more products from shoppers and process such orders, including issuing an order to the merchant whose web site provides the product information for the one or more products.

### CROSS-REFERENCE TO RELATED APPLICATION(S)

This application claims the benefit of U.S. Provisional Application No. 60/737,072, filed Nov. 15, 2005, the entire contents of which is incorporated herein by reference.

### FIELD OF THE INVENTION

The present invention relates to a computer program and system that scrapes or imports product offering data from an existing e-commerce web site, whether it be an e-commerce marketplace web site or an e-commerce shopping cart web site, and can create additional e-commerce marketplace web sites and in addition can create an e-commerce shopping cart web site. Furthermore, the system can use the obtained e-commerce web site data to expand the product offerings of another virtual e-commerce market-place web site.

### BACKGROUND OF THE INVENTION

This invention applies to merchants that host their own e-commerce store as well as to merchants that partner with dominant Marketplace e-commerce web sites such as Yahoo, eBay and Amazon. Both desire better tools to promote their product catalog across multiple channels while adding minimal complexity to day to day operations. For the purposes of this invention, the term web site refers to any on-line technology that allows non-authenticated access to product catalog data.

Merchants desiring to sell on the Internet have many choices regarding how they promote their products and about the actual process by which a customer can place an order. Merchants may promote their products via dominant marketplaces such as Amazon, eBay or Shop.com. In addition, merchants' products may be listed on comparison shopping engines such as NexTag, Shopzilla or PriceGrabber, and products may be promoted through other means such as affiliate programs, blogs, and advertisements on search engines.

For the hosting of the merchant's actual selling process, merchants can choose to host their own store, outsource hosting of their shopping cart or entire site to providers such as MonsterCommerce or Yahoo Stores, or sell their products through e-commerce marketplaces such as Amazon, eBay or Shop.com. Although there are many exceptions, often small stores or individuals sell via marketplaces, small businesses may partner with a service provider to outsource hosting of their store, and larger businesses will host their own e-commerce store. No matter what combination of hosting platforms and promotional channels that a merchant utilizes, the merchant desires to process orders efficiently. As merchants expand to multiple channels, it becomes more important to have a centralized inventory and order management system. For example, a small merchant may find that eBay's tools are sufficient for their eBay store. But if that merchant grows to the point of having an eBay store, an Amazon store, as well as their own presence hosted by Yahoo Stores, then the merchant's business processes become complicated. They will either have to fulfill orders using all three systems, likely in a uncoordinated manner, or the merchant needs a fourth system to centralize order fulfillment and to coordinate inventory among the three e-commerce platforms (as well as advertising channels such as comparison shopping engines).

A merchant today may utilize services such as from Channel Advisor, Channel Intelligence, Mercent, and Channel Velocity to promote their product data among various comparison shopping sites. However, these solutions often do not manage the order fulfillment process between the merchant and e-commerce marketplaces. If they do coordinate with e-commerce marketplaces, these prior art solutions either require that the merchant centralize their order tracking and processing software onto the provider's platform, or they expect that the merchant have an existing e-commerce platform for managing the order fulfillment process that can integrate with the provider's service. If the merchant is initially selling only through a dominant marketplace channel, however, the merchant will likely be using the marketplace's order fulfillment solution (e.g., tracking when an order is shipped or back ordered, printing shipping labels, and communicating with the customer about changes to the customer's order status) and not have one of their own which is capable of managing orders from multiple channels. Such merchants may desire to utilize a solution which creates a shopping cart based e-commerce system for the merchant that will allow the merchant to manage order processing of multiple channels as well as possibly to establish their own web store, distinct from their one or more existing marketplace stores. No solution that automatically creates such an e-commerce platform presently exists where the resulting service is entirely distinct from the solution provider's system. The present invention is designed to help merchants control their operations and integration with multiple sales and e-commerce channels as their business grows.

### SUMMARY OF THE INVENTION

A method for creating an online mall, comprising: obtaining product information for one or more products from merchant web sites, wherein the product information includes total price data for the one or more products; creating a shopping cart web site for at least one merchant as a function of the product information obtained from that merchant's web site; setting a new price for the one or more products on the created shopping cart web site, wherein the new price is responsive to the total price data for the one or more products and the on-line mall's own pricing analysis, and wherein the shopping cart web site is adapted to take orders for one or more products from shoppers and process such orders, including issuing an order to the merchant whose web site provides the product information for the one or more products.

### BRIEF DESCRIPTION OF THE DRAWINGS

FIG. 1 is a high-level block diagram of a system deployed at a service provider's web site with a number of different merchant e-commerce web sites identified as the environment, such as shopping cart sites with and without the service provider's service adaptors and e-commerce marketplace sites, as well as new merchant shopping cart e-commerce web sites established by the Market Place Creation portion of the service.

FIG. 2 is a diagram of event flow through the Market Place Creation service.

FIG. 3 is a high-level block diagram of a system deployed at the service provider's web site to establish a Super Mall marketplace.

FIG. 4 is a diagram of event flow through the Super Mall portion of a service for shallow or non-integrated merchants, with shopper-supplied feedback after the shopper receives the purchased product.

FIG. 5 is a diagram of event flow through the Super Mall portion of a service for deeply integrated merchants with the shopper returning the product after purchase.

FIG. 6 is a diagram of an example of a method for indexing and translating taxonomy.

### DETAILED DESCRIPTION OF THE INVENTION

Introduction

The invention involves an Internet service that can assist on-line merchants by providing one or more of the following:
1. The service obtains information from the merchants' e-commerce web site about a merchants' products, including their descriptions, images, availability, “total pricing” including product price, shipping, taxes, alternative prices such as quantity discounts, buy-it-now, initial bid and product bundling. The service can do this for a variety of e-commerce web sites, such as marketplaces and shopping cart sites.
2. The service can automatically build a shopping cart e-commerce web site for a cooperating merchant.
3. With the merchant's assistance, the service automatically fills a new marketplace (Yahoo Store, eBay etc.) web store to expand the reach of the merchant.
4. The service facilitates sales and aids product inventory control for the newly created marketplace web sites.
5. The service can further expand a merchant's Internet presence by inclusion of merchant products in a Super Mall marketplace operated by the service provider.

The present method and system used for the service allows merchants to expand their presence on the Internet in several ways. The system can regularly or on command retrieve product information from merchants' web sites. Product information/data includes but is not limited to “total pricing” data, including shipping, sales tax, base product price and possible alternative product prices such as quantity discount, initial bid or buy-it-now prices, on a variety of products from existing e-commerce web sites of interest. The system retrieves the product information and builds a long term data store for further use. In one example, the system uses retrieved product data to create an additional e-commerce marketplace web site for a merchant. To do so, the system provides a service to match the product taxonomy of that specific marketplace.

If a given e-commerce web site of interest from which data is retrieved is an e-commerce marketplace web site (e.g. eBay, Amazon, Overstock.com, or Yahoo Stores, where the merchant does not itself control the software upon which transactions are executed), then the system can use the “total pricing” data to both create an e-commerce shopping cart web site (i.e., leveraging shopping cart software such as osCommerce or VP-ASP) and to create additional e-commerce marketplace web sites for a participating merchant. This can give the merchant a permanent web presence and extend the merchant's presence into new marketplaces. However, if the e-commerce web site of interest from which data is retrieved is an e-commerce shopping cart web site, then the system can also create multiple e-commerce marketplace web sites for the merchant that interface with the existing shopping cart web site. (The merchant is required to sign up for a given marketplace but the system and service can populate and manage the flow of inventory to such a site.) In order to create an e-commerce shopping-cart web site the system preferably utilizes an existing shopping cart site designed to be totally database-driven with support for multiple sites and with automatic page generation.

Finally, the product information, for example, the “total pricing” data can be used to extend a merchant's product offering to a virtual e-commerce marketplace web site where the original site of interest merely serves as supplier and shipper, while the virtual marketplace sets the price and evaluates supplier performance.

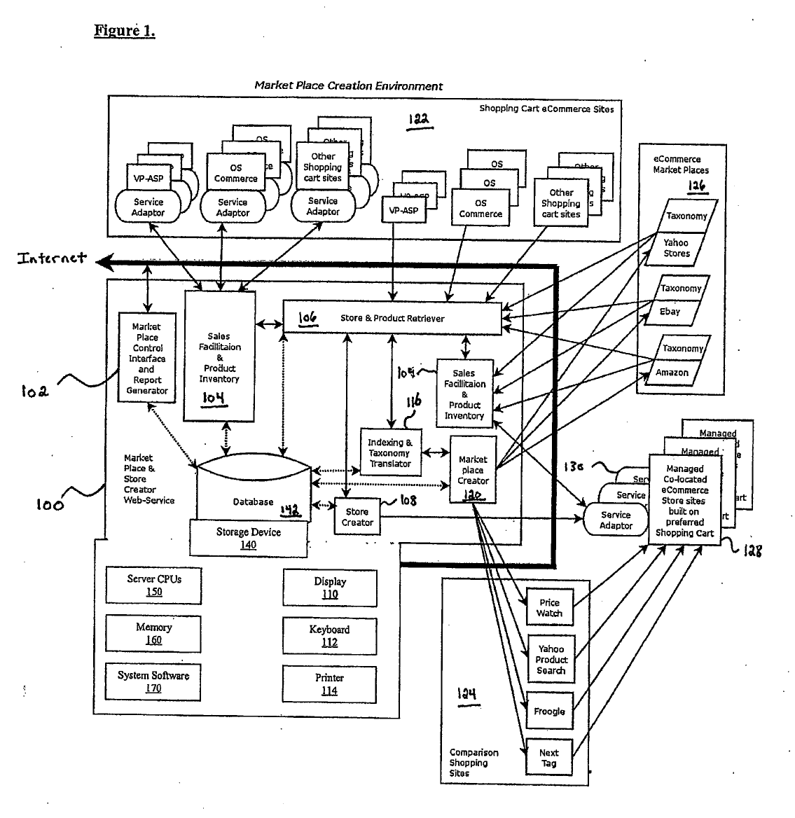

FIG. 1 is a high-level block diagram of an embodiment of the system deployed at the service provider's web site, with a number of different merchant e-commerce web sites identified as the environment. This includes shopping cart sites (with and without the service adaptors the system can provide) and e-commerce marketplace sites, as well as new merchant shopping cart e-commerce web sites established by the Market Place Creation portion of the service. The Sales Facilitation and Product Inventory module is drawn twice, but is actually just a single module. This was done to improve the clarity of the figure and reduce line crossover. This implies that the Sales Facilitation and Product Inventory module interfaces to the service database, even though one of the drawn modules omits depicting this connection, again for improved figure clarity.

Infrastructure

For all the embodiments below, the following hardware/software set up may be used to implement the invention: Dual Intel Xeon-based server with at least 2 Gb of memory, Windows 2000 Server, Microsoft SQL 2000, Internet Information Server 5.0, Microsoft's CDOSYS email component. A preferred embodiment would have multiple servers for database and application redundancy and isolation, and could also be built on other computing platforms.

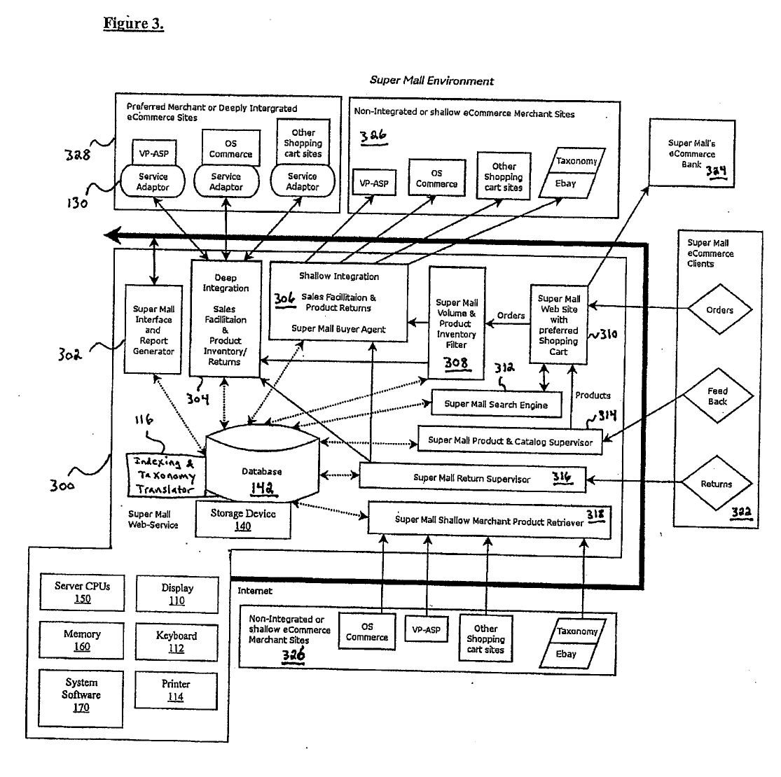

Referring now to FIGS. 1 and 3, the types of hardware and software within the computer system 100 and 300 may vary depending on the implementation. For example, certain embodiments may have components, such as the display 110, keyboard 112, and/or printer 114, depending upon the specific capabilities of system 100 and system 300. In addition, the computer systems 100 and 300 may support additional conventional functionality not described in detail herein, such as displaying images in a variety of formats, protecting the system from cyber-threats, allowing users to securely log into the system, and supporting administrative capabilities.

As is known in the art, the computer systems 100 and 300 are adapted to execute computer program modules for providing fimctionality described herein. As used herein, the term “module” refers to computer program logic or instructions for providing the specified functionality. A module can be implemented in hardware, firmware, and/or software components. Preferably, a module is stored on the storage device 140, loaded into the memory 160, and executed by server central processing units (CPUs) 150 in coordination with the above listed system software. As in the current state of the art, a typical e-commerce store is built around its long-term database storage 142. A typical e-commerce store keeps its product catalog and product inventory in its database 142 with all its associated data including shipping options, costs and margins.

As used in the present discussion, the term “product” may mean a good, such as an MP3 player, or a service, such as rug cleaning services, or a combination of goods and services, such as a computer and a maintenance services package. “Price comparison site” means any site where a user may see a listing of offerings of the same or substantially the same product offered by multiple merchants at different prices. This may be done in some kind of tabular form showing salient details for the different merchant offers or in simple lists of offered items (as in an auction site), with links that a customer may need to follow to find selling details.

Market Place Creation

The service enabled by the systems and methods shown provides a number of benefits for merchants who have no separate presence on the Internet or who look to marketplaces like Yahoo Stores to establish a marketplace presence on the Internet. First, it can create a more permanent Internet presence for the merchant by reading the product offering data from the merchant's marketplace web site and then using that data to populate a template driven “generic” e-commerce shopping cart driven web site maintained, but not necessarily hosted by the merchant.

Another benefit provided by the present service for merchants that have established a single Internet presence in an e-commerce marketplace web site is the ability to establish wider presence by spreading to multiple, additional marketplaces. The service does this by first reading the product offerings on the merchant's established marketplace web site. The merchant must sign up with these additional marketplace providers, but the inventive service can be of great assistance in facilitating launching these additional marketplaces. After the merchant establishes an account with the marketplace provider, then the service provider can populate the marketplace for the merchant. Thus, the merchant now has opened a second (or third, or fourth) marketplace store, thereby increasing their Internet presence.

Establishing a marketplace presence on the Internet means that the merchant must adopt the product category taxonomy established by the marketplace provider. For the small merchant with a limited product catalog, establishing their first presence this poses a small, yet manageable problem. However, for the serious merchant that has a large catalog of products this can pose a barrier to entry, especially if the merchant has already spent time and energy creating its own streamlined product category taxonomy. Thus, one of the features of this service and system is its taxonomy indexing and translation feature. As will be described, this leads to a benefit to multiple classes of merchants. For example, merchants with existing shopping cart sites can have more channels for their products, merchants with existing marketplace sites can make a smoother transition to a shopping cart based site and then extend to other channels, and all merchants can utilize the super mall marketplace supported by the system.

Some e-commerce marketplace web sites (e.g., many price comparison sites) do not place orders on their sites but instead redirect orders taken to the merchants for final fulfillment. Thus, a merchant that has an established presence using a shopping cart can expand into more market places than a merchant without such a presence. This is one motivation for the service to establish such shopping cart presences for merchants that do not have them. However, this presents the challenge of taking a merchant with its own shopping cart site and expanding its presence into a wide array of marketplace sites.

The service facilitates sales at marketplace sites that merely take orders without shipping them by providing a participating merchant with a single service adaptor that smoothly integrates one or more e-commerce marketplace sites into the merchant's existing shopping cart system.

In FIG. 1, one example of system 100 comprises a number of modules or components, including a “Market Place Control Interface and Report Generator” (MPCIRG) 102 component, a “Sales Facilitation and Product Inventory” (SFPI) 104 component, a “Store and Product Retriever” (SPR), 106 component, a “Store Creator”,(SC) 108 component, an “Indexing and Taxonomy Translator” (ITT) 116 component, a “Market Place Creator” (MPC) 120 component and a database 142.

The system 100 is connected to the Internet in order to access and import product offering data from shopping cart e-commerce sites 122, e-commerce market places 126, and price comparison shopping sites 124. In addition to accessing e-commerce sites across the Internet, the system 100 also uses the Internet to communicate with an outside ASP (Application Service Provider, not shown) that works closely with the inventive service and hosts those e-commerce Stores created by the system 100. As is the current state of the art a typical e-commerce store is built around its long-term database storage. A typical e-commerce store keeps its product catalog and product inventory in its database including costs and prices. The store's web pages then display products pulled from its database with all its associated, data including shipping options, costs and margins. The use of the imported data in a new store managed by the service is depicted in FIG. 1 by “Managed Co-located e-commerce Store Sites built on preferred Shopping Cart” 128. In other words, the system creates new e-commerce stores for participating merchants, but these stores are not necessarily hosted by the service. These stores that are built by the service are wholly driven by catalogs of products stored in a database, which may be hosted by the ASP, but can be periodically updated by the data access and importing activities of system 100. These stores will employ shopping cart software selected by the administrators of the service. Central to the design of the service is the Database 142, which interacts with every component of the invention and provides long-term data storage. Another centralized feature of the service is the MPCIRG 102. The MPCIRG 102 component is comprised of two sets of web pages; one set employs public access for client merchants to access service performance reports and the other set contains private web pages for use by service administrators. In order to carry out the administrative functions of the service, the MPCIRG 102 can communicate, control, monitor and operate the other components of the service in either a direct programmed fashion or indirectly through the database.

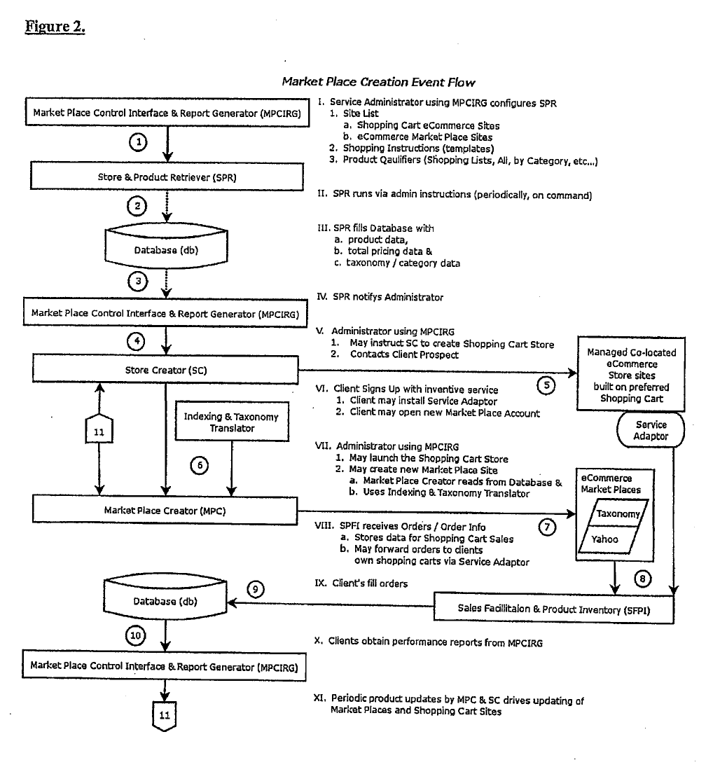

In FIG. 2 service administrators initially use the MPCIRG 102 to configure and control the SPR 106 component (FIG. 2, process 1). The SPR 106 component operates as a web crawler or robot (shopping robot) to collect product data from a store. The administrators provide the SPR 106 component with a URL (Universal Resource Locator) that points to the store, and either an RSS, Excel, .csv., or .xml file containing information about the store's product offering. It will often be the case that these stores will be prospective merchant clients of the service. In order to obtain total pricing data from these sites, the SPR 106 needs to know how to shop on each market place site or how to parse any file containing information about the store's product offering that the merchant makes available. This knowledge is maintained in the database 142 as a collection of templates, rules and instructions, which are accessible to the service administrators. In addition the administrators can instruct the SPR 106 to collect all products, products from a specific shopping list or products specified by category from a specific shopping list. Lastly, the administrator instructs the SPR 106 to run on command or periodically.

The SPR 106 runs and collects product data with its associated total pricing as well as information concerning the taxonomy or category information used by the store of concern (FIG. 2, process 2). The SPR 106 then stores this data in the database 142 (FIG. 2, process 3). The SPR 106 then notifies the administrator of its completion and its results (process 4).

The administrator can now decide selectively to take the output from the SPR 106 and to instruct the SC 108 component to set up a permanent shopping cart site in conjunction with the services' ASP partner (FIG. 2, process 5).

The SC 108 is configured with information on how to remotely contact the ASP, to create a new store and then forward the selected product data to the new store. In addition the SC 108 creates the structures for the new store in the service's database 142, as well. After this a representative from the service can contact the prospective client merchant for a sales call and demonstration of the newly created store. Should the client respond positively to the service sales call, then the administrator uses the MPCIRG 102 to put a new store into total operation by means of the service.

Up to this point in the description, the flow has concentrated on prospective merchant clients of the service that have marketplace e-commerce sites with no permanent Internet presence. Now that creating a more permanent presence on a shopping cart site has been described, we will describe how the service also may expand Internet presence by creating new marketplace sites. This needs to include merchants who previously had such a presence, which are represented in FIG. 1 as Shopping Cart eCommerce Sites 122. All client merchants that use the system 100 to expand and create additional market places first need to open an account with the new marketplace (e.g., Yahoo, Amazon). Those merchants that operate their own shopping cart e-commerce stores will need to install a service adaptor 130 (FIG. 2, process 6).

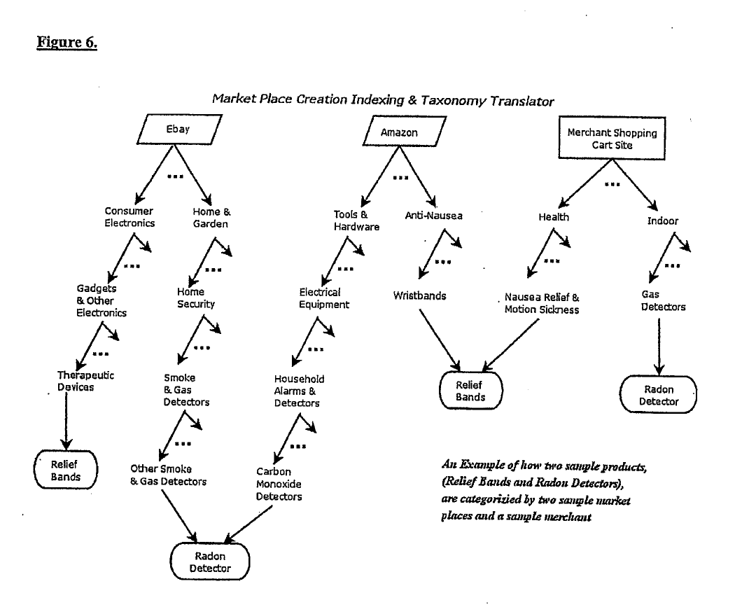

The service administrators use the MPCIRG 102 to create the new market place store by invoking the MPC 120 (FIG. 2, process 7). The MPC 120 uses product information in the services database in conjunction with the ITT 116. The ITT 116 regularly receives product/category data from the SPR 106 in order to learn the taxonomy of a market place store. Occasionally, the ITT 116 signals the service administrator for additional help. When invoked by the MPC 120 the ITT 116 places each of the products into the proper category. The ITT 116 is further described below with respect to FIG. 6. If the ITT 116 is missing a translation, this may require the intervention of the administrator. The MPC 120 sets up the service's database for a new marketplace site and prepares the stores data for transmission to the marketplace, which will have a defined XML or CSV file format.

Once a new shopping cart store or marketplace store is opened for a client merchant, then orders can be received by the SFPI 104 component (FIG. 2, process 8). The SFPI 104 logs orders into the system's 100 database 142 for further reporting and then forwards the order to the shopping cart site through the service's adaptor 130. The client merchant can then process the order (FIG. 2, process 9).

The client merchant is given a login as part of its sign up to the service so that it can access the MCPIRG 102 to analyze the success of the merchant's product line from their various expanded marketplaces and/or their hosted shopping cart site (FIG. 2, process 10). Internet merchants often change the products on their sites. As old inventory is sold off, products are removed and as new inventory is purchased new products are added to the site. Thus, for client merchants using the service adaptor 130 the SFPI 104 can receive changes to the client's product catalogs and trigger updates through the MPC 120 or the SC 108 via the service adaptor 130 employed by the service for their hosted shopping cart site (process 11).

Super Mall

The flow of products and vendors through the service provides an opportunity to create an additional marketplace for its merchant clients (as well as non-clients). This market place is virtual and may have advantages of access to multiple pricing and multiple vendors, many with established existing relationships and multiple taxonomies. The virtual marketplace (a.k.a. the Super Mall) rates vendor performance both as a service to shoppers and to decide with whom it wants to do business. Thus it maintains client satisfaction by use of only the better suppliers and merchants. The Super Mall is a virtual store populated with product data from merchants. Although the model has greater efficiencies with cooperative merchant relationships, it can also take on products on an “arbitrage” basis without necessarily obtaining the permission of the underlying merchants.

Super Mall is a marketplace with one or more of the following activities and features:
1) The product databases of many or only a few merchants are “scraped” for product offering data, or preferred merchants send product offering data directly to the service operating the Super Mall.
2) The Super Mall sells directly to customers, at a mark up to end consumers or potentially at merchants' asking prices due to discount purchase pricing negotiated with preferred merchants.
3) The Super Mall has an automatic agent that buys the item(s) from merchant(s) and has those merchant(s) directly ship to Super Mall customer.
4) The Super Mall with shopper feedback then rates how well the merchant does at delivering. If a merchant gets too much bad feedback, it is removed from the Super Mall.
5) If a shopper needs to refund an order, the Super Mall contacts the merchant to get RMA (Returned Merchandise Authorization) instructions for the Super Mall shopper to send the package directly to the merchant for return and replacement.
6) The Super Mall takes the credit card orders and is responsible for processing, tracking, fraud, etc.
7) The Super Mall offers merchants incentive to become “preferred merchants” as they achieve a certain level of scale. Using the Super Mall deep integration adaptor automates the merchant's order flow, handles merchant payment (via ACH deposit), and provides a process for managing feedback, returns, replacements, etc.
8) Preferred Merchants will receive preferential listing on the Super Mall's search engine. The engine can determine what the cost of a channel is based on the level of integration, feedback/return history of that merchant. This cost can be used to assess the profitability of a given product or channel. The Super Mall's search engine will also use this in determining whether it shows a given product or merchant.

The Super Mall sells directly to customers by taking orders, processing credit cards and coordinating shipments and client satisfaction. The Super Mall employs volume sales detectors that guide the Super Mall administrators and agents to expand offerings of hot selling products. Thus, Super Mall can aggregate demand and approach merchants with risk-free orders in hand to negotiate product discounts and pricings. Such orders are strong motivators for most merchants, given that they are relieved from advertising fees, processing fees and fraud. This should convince merchants that the Super Mall is not in conflict with their business, but an extended presence and added benefit.

The Super Mall seeks out “preferred merchants” based on shopper feedback, (i.e., past merchant performance), volume sales, product discount and pricings and existing market place creation clients for deeper integration. A deep Super Mall integration uses an identical Service Adapter to merchant's using the taxonomy translation and order integration service. Such integration provides merchants with better placement from the Super Mall search engine, improved order flow, up to date product listing, better payment handling (via ACH deposit) and provides a stronger process for managing feedback, returns and replacements.

A key difference between the Super Mall and the conventional price comparison sites is that the latter show data but do not actually take orders or process transactions. A key difference between the Super Mall and a marketplace like amazon.com is that on Amazon, the merchant must sign up and send their data to Amazon, and the merchant sets the price. In the present model, the merchant does not necessarily sign up with the Super Mall. The Super Mall can get and present the product data similar to a price comparison site, but it takes the order directly and has the merchant be a virtual drop shipper for the sale. To avoid copyright infringement issues, the Super Mall may wish to provide its own product photograph and prepare original text for the product offering as it appears on the Super Mall. Another difference between the Super Mall and conventional price comparison sites is that the Super Mall sets its own price for the particular products. The Super Mall takes the total pricing data of the products collected from the merchant's web sites and, responsive to the total price data, either maintains or adjusts the price. The Super Mall may sell the products at a higher price to make a profit. The Super Mall may also have a contract with the manufacturers or other promoters of the products that allows the Super Mall to sell the product at the same total price as the merchant or at a price lower due to a rebate program or volume of sales incentive. The Super Mall may also sell the products at the total price or at a price lower than the listed total price because of an arrangement with the merchant such as in the case of a preferred merchant as described below. The price at which the Super Mall sells each of the products can be determined and adjusted using a price-demand curve analysis or other price setting analysis as described in U.S. application Ser. No. ______, filed Nov. 15, 2006, entitled “System for On-line Merchant Price Setting” and is hereby incorporated by reference in its entirety.

In FIG. 3, one example of the architecture of a Super Mall (SM) system 300 is shown. A Super Mall offers a grouping of products that can be either large or small in scale. In this embodiment, SM system 300 comprises a “Super Mall Interface and Report Generator” (SMIRG) 302 component, a “Super Mall Sales Facilitation and Product Inventory/Returns” (SMSFPIR) 304 component, a “Super Mall Buyer Agent” (SMBA) 306 component, a “Super Mall Volume & Product Inventory Filter” (SMVPIF) 308 component, a “Super Mall Web Site” (SMWS) 310 component, a “Super Mall Search Engine” (SMSE) 312 component, a “Super Mall Product & Catalog Supervisor” (SMPCS) 314 component, a “Super Mall Return Supervisor” (SMRS) 316 component, a “Super Mall Product Retriever” (SMPR) 318 component, and a database 142.

The SM system 300 is connected to the Internet in order to access Preferred Merchant e-commerce sites 328, non-integrated e-commerce merchant sites 326, a Super Mall e-commerce bank 324, and Super Mall e-commerce clients 322. As is the current state of the art, a typical e-commerce store is built around its long-term database storage. A typical e-commerce store keeps its product catalog and product inventory in its database including costs and prices. The store's web pages then display products pulled from its database 142 with all its associated data including shipping options and costs. The Super Mall system 300 is no exception and employs a conventional shopping cart 310 that is the preferred choice of the Super Mall administrators. Central to the design of the Super Mall system 300 is the database 142, which interacts with every component of the invention and provides long-term data storage. Shopping cart software 310 processes credit cards as part of their functionality and this is depicted by a connection to the Super Mall's e-commerce Bank 324.

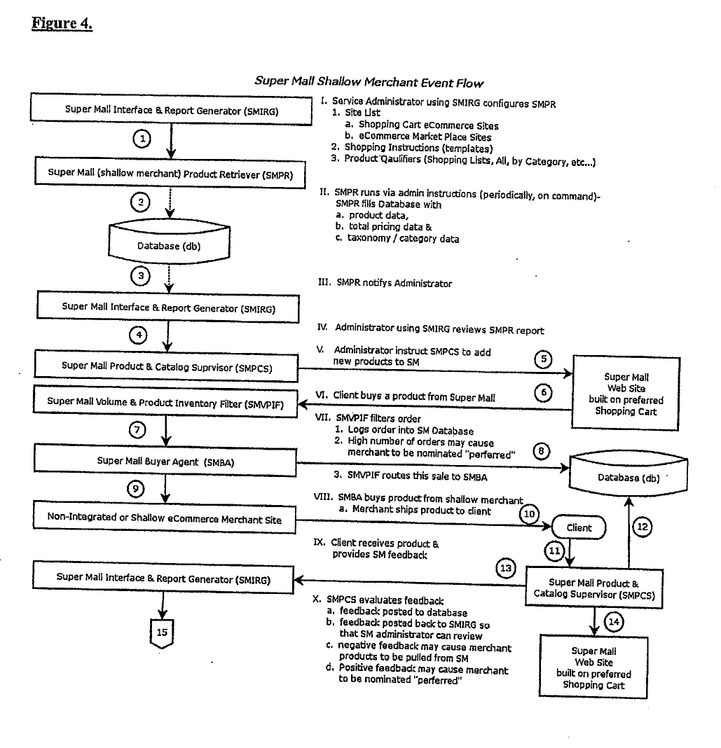

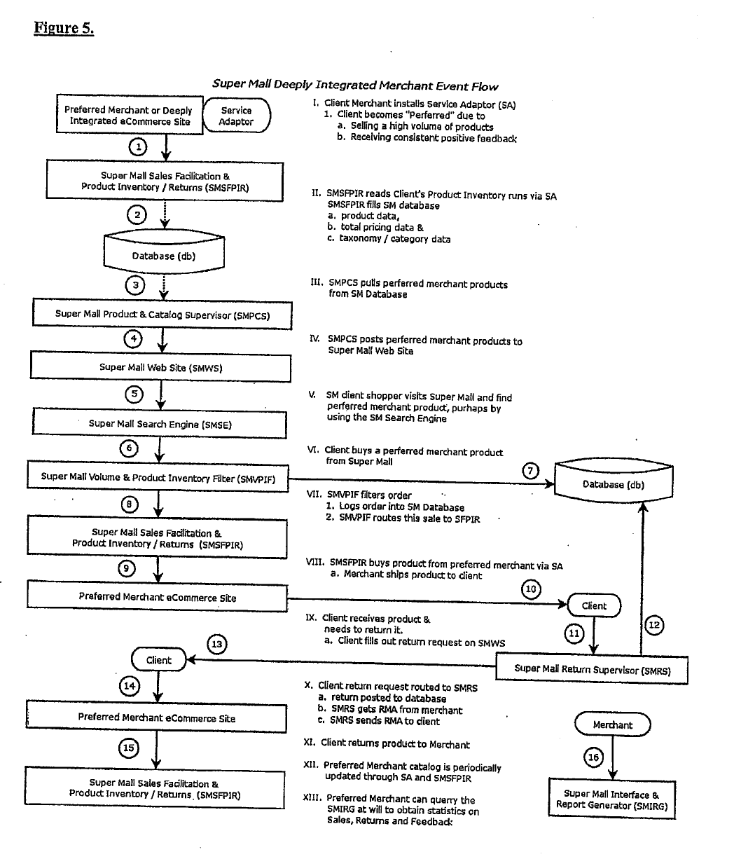

The Super Mall system uses merchants that fall into two classes: ‘preferred’ or deeply integrated merchants and ‘shallow’ merchants. Preferred merchants that operate their own preferred e-commerce shopping cart sites 328 are merchants that are well known to the Super Mall system 300 and have installed the Service Adaptor (SA) 130 to facilitate data flow and e-commerce more smoothly. FIG. 5 depicts the events that occur when client shoppers buy products from preferred merchants through the Super Mall system 300. Shallow merchants are not well known to the Super Mall system 300 and do not have the SA 130 installed on their non-integrated e-commerce sites 326. FIG. 4 depicts the events that occur before, during and after a Super Mall system 300 shopper buys a product from a shallow merchant.

Super Mall system 300 shoppers interact using basically three actions: they buy or purchase products, which results in an order, they provide feedback to the Super Mall both positive and negative and they may need to return a product they have purchased. FIG. 5 shows the event flow when a shopper needs to return a purchased product while FIG. 4 shows the event flow when shoppers provide feedback to the Super Mall system 300.

Another centralized feature of the SM system 300 is the SMIRG 302. The SMIRG 302 is comprised of two sets of web pages; one set employs public access for preferred client merchants to access service performance reports and the other set contains private web pages for use by service administrators. In order to carry out the administrative functions of the SM system 300 the SMIRG 302 can communicate, control, monitor and operate the other components of the Super Mall system 300 in either a direct-programmed fashion or indirectly through the database 142.

Shallow Merchant

Before a shopper can buy a product, the product must make its way into the Super Mall catalog. In FIG. 4, service administrators initially use the SMIRG 302 to configure and control the SMPR 318 component (FIG. 4, process 1) for a product from a shallow merchant The SMPR 318 component operates as a web crawler or robot (shopping robot) to collect product data from a store of a shallow merchant. The administrators provide the SMPR 318 with the non-integrated e-commerce store 326 URL. It will often be the case that these stores will be prospective preferred merchants. In order to obtain total pricing from these sites the SMPR 318 needs to know how to shop on each e-commerce site. This knowledge is maintained in the database 142 as a collection of templates, rules and instructions, which are accessible to the service administrators. In addition the administrators can instruct the SMPR 318 to collect all products, products from a specific shopping list or products specified by category from a specific shopping list. Lastly, the administrator instructs the SMPR 318 to run on command or periodically.

The SMPR 318 runs and collects product data with its associated total pricing as well as information concerning the taxonomy or category information used by the store of concern (FIG. 4, process 2). The SMPR 318 stores this data in the database 142 (FIG. 4, process 3). The SMPR 318 then notifies the administrator of its completion and its results (FIG. 4, process 4).

The administrator can now decide to add the retrieved products to the Super Mall Catalog using the SMIRG 302 to instruct the SMPCS 314 to add the products to the Super Mall Catalog and Web Site (FIG. 4, process 5). Now the stage is set for a client shopper to purchase products from the Super Mall system 300.

When a shopper purchases a product from the Super Mall system 300 an order is generated and sent to the SMVPIF 308 (FIG. 4, process 6). The SMVPIF 308 identifies the order as a purchase of a product from a shallow merchant, adds the sale to its internal count of similar sales and tests the new total against internal thresholds to determine if the shallow merchant needs to be nominated for “preferred” merchant status based on high sales volume and then routes the order to the SMBA 306 (FIG. 4, process 7).

The SMBA 306 logs the order into the database 142 (FIG. 4, process 8). The SMBA 306 buys the product from the shallow merchant with shipping instructions for the purchase to go directly to the shopper (FIG. 4, process 9). The shallow merchant receives the SM system 300 order and ships the purchase to the shopper (FIG. 4, process 10).

In some cases the event flow will stop with the client happily receiving their purchase, but that will not always be the case. For our purposes we will continue the event flow with the shopper providing feedback to the Super Mall system 300 (FIG. 4, process 11). The SMWS 310 directs shopper feedback to the SMPCS 314 which logs all feedback into the database 142 (FIG. 4, process 12). In addition the SMPCS 314 evaluates the feedback. If this merchant has received too much negative feedback, then the SM administrator needs to be alerted through the SMIRG 302 (FIG. 4, process 13). Too much negative feedback can also cause the shallow merchant's products to be pulled from the SM system 300 by the SMPCS 314 (FIG. 4, process 14). However, positive feedback in quantity can lead the SMPCS 314 to nominate the shallow merchant for “preferred” status, which is again reported to the administrator through the SMIRG 302 for further action (FIG. 4, process 15).

Preferred Merchant Referring now to FIG. 5, when a merchant gains “preferred” status it could be because they sell products in high volume with low negative feedback or through high volumes of positive feedback. In one embodiment, the system may identify shallow merchants that should be promoted to preferred merchants based on an arbitrage analysis. For example, if a shallow merchant sells a product for $100 and there is little price transparency for this product, the operator of the Super Mall may determine from its own pricing analysis (including a price setting analysis as described in U.S. application Ser. No. ______, filed Nov. 15, 2006, entitled “System for On-line Merchant Price Setting”) that it is able to sell that product for $140, and pay the shallow merchant $100 per sale, netting a $40 profit. As the number of other channels in which the product is advertised increases, the Super Mall operator may only be able to sell the product for $120.

The system can also calculate the overhead of servicing a shallow merchant. For example, if 5% of products sold by a given shallow merchant are returned, and each return costs the Super Mall operator $100 in direct costs, then the overhead for returns per order is 5% * $100=$5. Also if the direct costs of placing an order for a shallow merchant are $5 due to time required to manually place the order on the shallow merchant's site, then the expected total overhead for that merchant is $10. This system may also add, for example, a 50% of the total overhead penalty for the opportunity cost of deploying the Super Mall's staff toward processing these orders, bringing the total overhead per order to $15. hI this example, the expected profit per sale is $120−$100 (cost)−$15 (overhead)=$5. If the expected profit is $5 per sale and the volume of sales for that merchant's product through the Super Mall is at a rate of 1,000 units per year, then the Super Mall operator would expect to make $5,000 annually in profit (adjusted for opportunity costs) via sales of this product by this shall merchant. If the Super Mall typically negotiates a 10% commission with preferred merchants on sales made through the Super Mall, the Super Mall operator might expect to earn $10,000 (1,000 sales*10% commission*$100merchant sales price) per year from the merchant's sales of this product if the merchant were a preferred merchant. (The actual expected profit amount may be higher due to increased sales through the Super Mall by offering the product for sale at $100 instead of $120. If the Super Mall operator has sufficient detail on the supply-demand curves for this product, the Super Mall operator may account for this expected profit increase as well.) If the profits the Super Mall operator expects from this merchant for all of the merchant's products if the merchant were a preferred merchant (in this case $10,000) exceeds the expected profits from this merchant remaining as a shallow merchant (in this case $5,000) by some threshold which accounts for the direct and opportunity costs of negotiating and helping the merchant convert to a preferred status (say $3,000), then this merchant should be highlighted as a candidate for elevation to a preferred merchant status. The Super Mall operator may sort a list of such candidate merchants by the expected additional profit from converting each merchant to a preferred merchant, and prioritize their conversion efforts accordingly.

To elevate a shallow merchant to a preferred merchant, the merchant will install the Super Mall's Service Adaptor (SA) 130 module on their site, which facilitates better data communications between the merchant and the Super Mall system 300 (FIG. 5, process 1). It might be the case that the merchant's product catalog is already part of the Super Mall catalog, however, all further changes in product catalog will be carried out through the SA 130 and the SMSFPIR 304 component (FIG. 5, process 2). The SMSFPIR 304 will load the preferred merchant product catalog into the database 142 (FIG. 5, process 3). The SMSFPIR 304 will notify the SMPCS 314 that the SM catalog and SMWS 310 need updating.

The SMPCS 314 will update the SMWS 310 with the preferred merchant's products (FIG. 5, process 4). Now Super Mall shoppers can find the preferred merchants products on the SMWS 310, perhaps by using the SMSE 312 (FIG. 5, process 5). As was seen earlier, when a shopper purchases a product from SM system 300 the order is first sent to the SMVPIF 308 (FIG. 5, process 6). The SMVPIF 308 is used for volume filtering and database logging (FIG. 5, process 7). However, in this case the product is from a preferred merchant, so the SMSFPIR 304 is invoked (FIG. 5, process 8).

The SMSFPIR 304 efficiently buys the product from the preferred merchant (FIG. 5, process 9). The SMSFPIR 304 has the merchant ship the purchase directly to the shopper (FIG. 5, process 10). This is often where the normal event flow will stop with a happy client, but for our purposes we will assume that the client needs to return the product. The SMWS 310 will direct the return request to the SMRS 316 for processing (FIG. 5, process 11). The SMRS 316 will log the return request into the database 142 (FIG. 5, process 12). The SMRS 316 will obtain a Return Merchandise Authorization (RMA) from the merchant and then forward the RMA to the shopper (FIG. 5, process 13). The client shopper can then use the RMA to return the purchase directly to the preferred merchant (FIG. 5, process 14).

Recall it was previously mentioned that as a preferred merchant makes changes to their product catalogs, the updates are brought into the SM system 300 by the SMSFPIR 304 component (FIG. 5, process 15). In addition, a preferred merchant can always use the SMIRG 302 to track their SM sales, returns and feedback (FIG. 5, process 16).

Taxonomy Mapping

In FIG. 6 one embodiment of the Indexing & Taxonomy Translator (ITT) 116 is shown. In this embodiment each leaf node on the marketplace's category mapping must map to a leaf node on the “Master Category” list of the service provider's system 100, 300 that offers client merchants extensions to other marketplaces. This mapping is not necessarily 1 to 1, in that multiple marketplace categories might map to a single Master Category or vice versa.

The mapping table shown below serves two functions:

1) To be able to translate from a marketplace category to a client merchant store's category or vice versa. This helps to promote products to other channels.

2) To provide a mechanism for tracking the sales rank on a per category basis and using this to estimate whether a given product would be a good addition to the service provider's Super Mall. (e.g., if the service provider's system finds a new Amazon product in an Amazon category, and that maps to the service provider's radon detector category, the service provider can estimate the sales interest of that product based on the sales of other same category products the Super Mall sells).

| | | | | MarketPlace | |
|---|---|---|---|---|---|
| MasterCategoryName | MasterCategoryParent | MasterSalesRank | RefundRate | Name | MarketPlaceLeafCategory |
| Radon Detector | Gas Detectors | 2% | 1% | Amazon | Carbon-Monoxide-Detectors |
| | | | | | (note: Amazon has no Radon |
| | | | | | or other gas detector |
| | | | | | category) |
| Radon Detector | Gas Detectors | 2% | 1% | eBay | Other Smoke & Gas |
| | | | | | Detectors |
| Carbon Monoxide | Gas Detectors | 5% | 10% | Amazon | Carbon-Monoxide-Detectors |
| Detector | | | | | |
| Carbon Monoxide | Gas Detectors | 5% | 10% | eBay | Carbon Monoxide Detectors |
| Detector | | | | | |

How to use this mapping:

If the service provider has a Radon Detector derived from a product offering on eBay and wants to list that product on Amazon, the service provider needs to show it as a carbon-monoxide-detector category for Amazon (closest match). If the service provider spiders an Amazon store and finds a product within the carbon-monoxide-detector category, the service needs to decide whether to put it in the service provider's MasterCategory Radon Detector or the MasterCategory Carbon Monoxide Detector, which are both possible maps. One way to test for the correct map is to test whether the Amazon product listing for the candidate product contains greater word density of the words ‘Radon Detector’ or the words ‘Carbon Monoxide Detector.’ If this approach does not lead to resolution, then the system can flag a translation problem and the service provider can queue the problem for application of human judgment to the candidate product description.

If a given Amazon product is placed into the Radon Detector category, the service provider can then use the SalesRank of 2% for that category as an input to determine whether the service provider wants to list that product in the Super Mall (other possible decision inputs would be refund rate for that product category, experience with that merchant, typical mark up for that product, etc.). So this aspect of the logic allows the service provider to translate categories from merchants into a common taxonomy as well as to estimate the likelihood of selling a given product or product category at a profit via the Super Mall. Data can be collected to enhance this service both from the Super Mall's own sales as well as from other merchants who list their products through the product translation and order integration service. Client merchants gain the benefit of not having to find categories for each product themselves, as they benefit from the database mapping contributed by other participants and accumulated in the ITT module 116. As of November 2006, some comparison shopping engines such as NexTag and Shopping.com are now providing automatic taxonomy translation as part of their data importing process. However, there are key differences between the approaches of the comparison shopping engines and of the system described herein. Fundamentally, the system herein not only organizes and translates category taxonomies among merchants, but it also provides a means of effectively translating category taxonomy from a merchant site channel (e.g. a merchant's eBay store) to another merchant site channel (e.g. the merchant's Amazon store). So while comparison shopping systems may translate data from many merchants or merchant channels into a common taxonomy, the present system translates taxonomy data from many merchants or merchant channels into a common taxonomy and/or other merchant channels.

From the above description and drawings, it will be understood by those of ordinary skill in the art that the particular embodiments shown and described are for purposes of illustration only and are not intended to limit the scope of the present invention. Those of ordinary skill in the art will recognize that the present invention may be embodied in other specific forms without departing from its spirit or essential characteristics. References to details of particular embodiments are not intended to limit the scope of the invention.

We claim:

1. A method for creating an online mall, comprising:
obtaining product information for one or more products from merchant web sites, wherein the product information includes total price data for the one or more products;
creating a shopping cart web site for at least one merchant as a function of the product information obtained from that merchant's web site;
setting a new price for the one or more products on the created shopping cart web site, wherein the new price is responsive to the total price data for the one or more products and the on-line mall's own pricing analysis, and wherein the shopping cart web site is adapted to take orders for one or more products from shoppers and process such orders, including issuing an order to the merchant whose web site provides the product information for the one or more products.

2. The method of claim 1, further comprising obtaining shopper feedback for at least one merchant to whom an order is issued.

3. The method of claim 2, further comprising rating at least one merchant to whom an order is issued as a function of the shopper feedback obtained for each merchant.

4. The method of claim 2, wherein a merchant to whom an order is issued who receives sufficient negative shopper feedback is removed from the online mall.

5. The method of claim 1, further comprising handling order refunds by contacting a merchant to whom an order is issued and organizing the return of the purchased product from a shopper to the merchant.

6. The method of claim 1, further comprising identifying preferred merchants, wherein preferred merchants are provided software to process at least one of automated orders, merchant payment, customer feedback, product returns, and product replacements.

7. The method of claim 6, wherein preferred merchants receive preferential listing on the online mall.

8. The method of claim 6, wherein preferred merchants are based on products sold in high volume with low negative feedback or a high volume of positive feedback.

9. The method of claim 6, wherein preferred merchants are identified based on the expected profit to the online mall being greater if the merchants became preferred.

10. The method of claim 1, further comprising populating additional marketplaces for merchants using the product information for the one or more products.

11. The method of claim 1, wherein obtaining product information from merchant web sites comprises obtaining at least one of product description, product images, product availability, product price, shipping cost of the product, taxes, and quantity discounts for the product.

12. A method of selling merchandise online comprising:
configuring a shopping robot;
applying the shopping robot to at least one merchant web site, wherein the shopping robot collects product data from the at least one merchant web site;
storing the product data collected from the at least one merchant web site;
adding products offered by the at least one merchant to a maintained web site;
receiving orders from shoppers for at least one of the products added on the maintained web site;
buying the at least one product ordered by the shopper from the at least one merchant; and
directing the merchant to ship the at least one product bought directly to the shopper.

13. The method of claim 12, further comprising receiving feedback from the shopper.

14. The method of claim 13, further comprising removing products offered by the at least one merchant from the maintained web site as a function of the customer feedback.

15. The method of claim 13, further comprising changing the status of the at least one merchant to that of a preferred merchant as a function of the shopper feedback.

16. A method of increasing Internet presence of a merchant's products comprising:
configuring a robot;
applying the robot to at least one merchant web site, wherein the robot collects product offering data from the at least one merchant web site;
storing the product offering data collected from the at least one merchant web site; and
creating a new store with a shopping cart, wherein the store lists the product offering data collected from the at least one merchant web site.

17. The method of claim 16, wherein the robot collects product offering data from one of an RSS, Excel, .csv., or .xml file containing information about the at least one merchant web site's product offering.

18. The method of claim 16, further comprising categorizing the product offering data to conform to at least one new marketplace indexing taxonomy and transferring the categorized product offering data to the at least one new marketplace.

19. A method of increasing online presence of a merchant, comprising:
obtaining an existing online product offering of a merchant to collect product offering data for at least one product;
providing taxonomy translation to translate a category used for the existing online product offering for the at least one product into an appropriate different category for offering the at least one product on a new marketplace; and
providing a sales facilitation and product inventory component and a service adapter for an existing shopping cart used by the merchant to receive and process an order for the at least one product initiated at the new marketplace.

20. A system for increasing online presence of a merchant, comprising:
a robot for deriving from an existing online product offering of a merchant, product offering data for at least one product;
a taxonomy translation component for translating a category used for the existing online product offering for the at least one product into an appropriate different category for offering the at least one product on a new marketplace; and
a sales facilitation and product inventory component and a service adapter for an existing shopping cart used by the merchant for receiving and processing a shopper's order for the at least one product initiated at the new marketplace.
